(19) United States
(12) Patent Application Publication
(10) Pub. No.: US 2018/0038765 A1
(43) Pub. Date: Feb. 8, 2018

(54) CONTAINMENT TESTING DEVICES, METHODS, AND SYSTEMS

(71) Applicant: KEVIN P. WHEELER, Blackfoot, ID (US)

(72) Inventor: KEVIN P. WHEELER, Blackfoot, ID (US)

(21) Appl. No.: 15/657,048

(22) Filed: Jul. 21, 2017

Related U.S. Application Data
(60) Provisional application No. 62/371,762, filed on Aug. 7, 2016.

(51) Int. Cl. G01M 3/32

(52) U.S. Cl. CPC G01M 3/3209

(57) ABSTRACT

Systems, methods and devices for testing the tightness of containment systems are disclosed. The containment testing device may include: a base portion, a wall portion that may include an exterior surface, and an inflatable seal member for providing a temporary seal between a containment testing device and a containment system.

### CROSS-REFERENCE TO RELATED APPLICATION

This application claims the benefit of and priority to the filing date of U.S. Provisional Application No. 62/371,762, filed on Aug. 7, 2016. The entire contents of U.S. Provisional Application No. 62/371,762 is incorporated herein by reference as part of this application.

### BACKGROUND

### Technical Field

The disclosure relates at least to containment testing devices, methods, and systems.

### Discussion of Related Field

There are approximately 563,000 underground storage tanks (UST's) in the United States that store petroleum and other substances. (See the Federal Government of the United States' Environmental Protection Agency's website: https://www.epa.gov/ust, accessed Jul. 23, 2016). UST's and other storage units often include a variety of containment systems or units. For instance, UST's may include turbine sump containments, dispenser sump containments, spill containments, vapor recovery containments, transitional/intermediate sump containments and/or other containment systems. Each containment system may perform a different function. For example, spill containments may be designed to catch spilled fuel from the refilling process and to prevent the captured liquid from contaminating the surrounding environment. Turbine sump containments may be designed to provide access to turbine sump systems. Notwithstanding their differences, each containment system may be designed to house important equipment for the proper functioning of the UST and protection of the environment. Given the number of UST's, the potential environmental safety concerns, and possible regulatory requirements, it is important to ensure that containment systems work properly. The present disclosure provides devices, methods and systems for testing the liquid and/or air tightness (hereafter “tightness” or “tight”) of containment systems.

There are various methods for testing the tightness of containment systems. For example, the hydrostatic testing method may be accomplished by a tester who fills a spill bucket (part of a spill containment system), a turbine sump containment or other containment system with water measured to within 1/16 of an inch. The tester may then let the water stand for approximately an hour and then measure the water level again. If the water level is observed to have dropped less than ⅛ of an inch, the containment system is considered tight. Otherwise, the containment system is not considered tight. Once the testing is completed the water is removed from the containment system and disposed of.

The hydrostatic testing method has some drawbacks. For instance, accurately measuring water levels may be difficult in light of various factors. First, surface tension or other properties of water may make it difficult to get accurate water measurements. Second, water may evaporation on hot days or freeze on cold day and/or other weather conditions may affect water levels. Third, debris falling into the containment system may negatively affecting measurements. Fourth, it may be difficult to measure water levels in exactly the same spot for both measurements, thereby potentially affecting the measurements. Fifth, the hydrostatic testing method may take an hour or longer to complete. Sixth, the water must be removed and properly disposed of (especially if the water is contaminated).

Another method of testing the tightness of containment systems includes the vacuum testing method. The vacuum testing method may be accomplished by isolating the containment system from the tank and then applying negative pressure to 30.0 inches of water column. After the appropriate test pressure is achieved the vacuum source is turned off and the pressure in the containment system is monitored. If a drop in negative pressure less than 4.0 inches of water column is observed, the containment system is declared tight. Otherwise, the containment system is not considered tight.

Because containment systems come in various sizes, there is a need for a tightness testing device that can perform the vacuum testing method on targeted containment systems of various sizes. In addition, there is a need for a tightness testing device that can create a positive and negative pressure seal in order to check integrity of testing equipment. Furthermore, there is a need for such a testing device to have pressure sensing equipment that is sensitive enough to see changes of 0.1 inches of water column.

In light of the disadvantages of the hydrostatic testing method and/or needs associated with the vacuum testing method, there is at least a need for improved containment testing device(s), method(s) and/or system(s).

### SUMMARY

In one aspect, a containment testing device may include: a base portion; a wall portion including an exterior surface; and an inflatable seal member situated on at least an aspect of the exterior surface, wherein the inflatable seal member, when inflated, may provide a temporary seal between the containment testing device and a containment system.

Implementations may include one or more of the following features. The containment testing device may include: a first ledge portion and a second ledge portion, wherein the inflatable seal member may be situated between the first ledge portion and the second ledge portion, wherein the first ledge portion and second ledge portion may guide the direction the inflatable seal member expands and support it when the inflatable seal member is inflated. The containment testing device may include a handle. The containment testing device may include: a first port, a second port, a third port, and a fourth port. The containment testing device may include: a first valve, a second valve, and a third valve. The inflatable seal member may include a fill line for inflating the inflatable seal member. The fill line may be disposed through the fourth port and be operably connected to the first valve, wherein the first valve may be capable of controlling the flow of air going into and coming from the inflatable seal member and may be capable of being operably connected to a compressor for inflating the inflatable seal member. The second valve may be disposed through the second port and may be capable of being operably connected to a manometer for monitoring the level of pressure in the containment system. The third valve may be disposed through the third port and may be capable of being operably connected to a compressor for providing positive and negative pressure to the containment system. The containment testing device may be designed to test the tightness of a spill containment system. The containment testing device may be designed to test the tightness of a turbine sump containment system. The containment testing device may be configured to test the tightness of containment systems of various sizes. The containment testing device may be configured to provide positive and negative pressure to the containment system. The containment testing device may be configured with a means for measuring a change in pressure of at least 0.1 inches of water column in the containment system. The containment testing device may include an inspection camera system for visualizing leaks in the containment system. At least an aspect of the base portion may be configured from transparent material for visualizing leaks in the containment system. A support device may operably connect to the containment testing device to provide stability and support to the containment testing device.

In another aspect, a containment testing device may include: a base portion; a wall portion comprising an exterior surface; and a means for providing a temporary seal between the containment testing device and a containment system, wherein said means is inflatable.

In another aspect, a method of using a containment testing device to test the tightness of a containment system, wherein the containment testing device may include: a base portion; a wall portion comprising an exterior surface; and an inflatable seal member situated on at least an aspect of the exterior surface, wherein the inflatable seal member, when inflated, provides a temporary seal between the containment testing device and a containment system; wherein the containment system may include at least one cover; wherein the method may include: removing the at least one cover from the containment system; installing the containment testing device at least partially inside the containment system and inflating the inflatable seal member to form a temporary seal between the containment testing device and the containment system; applying positive pressure within the containment system to test the tightness of the seal between the containment testing device and the containment system; applying negative pressure within the containment system to test the tightness of the containment system; and monitoring the level of pressure inside the containment system to determine whether the containment system is tight.

Implementations may include one or more of the following features. The containment system may include a fill pipe; wherein the monitoring of the level of pressure inside the containment system may be performed by use of a manometer; wherein the method of using the containment testing device to test the tightness of the containment system may further include installing and inflating an inflatable plug in the fill pipe in order to isolate the containment system and control the tightness test of the containment system; and maintaining the inflated state of the inflatable plug until testing is complete.

These general and specific aspects may be implemented by using systems, apparatuses, devices, means, methods and structures and/or any combination thereof. Certain implementations may provide one or more of the following advantages. Embodiments may not achieve any or all of the listed advantages. Further, this is not an exhaustive list of all possible advantages of the disclosure. One or more embodiments of the disclosure may be configured to be and/or provide users the following.

In one or more embodiments, the disclosure may be designed to test the tightness of various containment systems such as spill containment systems, turbine sump containments, dispenser sump containments, vapor recovery containments, transitional/intermediate sump containments and/or other containment systems.

In one or more embodiments, use of the disclosure to test the tightness of a containment system may be done without using water and/or less use of water as compared to the hydrostatic testing method. In one or more embodiments, the disclosure may use a “side” seal method as opposed to sealing the very top of the containment. In one or more embodiments, the disclosure may provide a pneumatically actuated seal that may provide a sealing pressure of up to 100 psi against the side of the containment system or between a containment testing device and the containment system. In one or more embodiments, after actuating the seal, positive pressure and a leak detection solution may be used to verify that there are no leaks between the containment testing device and the containment that would affect the test results. In one or more embodiments, once the seal has been verified the containment may then be tested under negative pressure to prove if it is tight or not. In one or more embodiments, if the containment fails the test, a leak detection solution may be applied inside the containment and the containment may be tested again. In one or more embodiments, the containment test device can be removed to visibly check for signs of leakage.

In one or more embodiments, in addition to and/or alternative to the negative pressure vacuum method for leak detection, the disclosure may employ positive pressure to the containment system using a trace gas (helium). In one or more embodiments, a helium detector may be used to find traces of helium in the backfill surrounding the containment. Such a method used in conjunction with the vacuum method above, may allow a user to prove that the containment is or is not tight, as well as whether leaks from the contaminants are or are not going out into the environment.

In one or more embodiments, the disclosure may be configured to test containment systems with a range different sizes of openings, such as openings with about a 9-inch diameter to about a 60-inch diameter. In one or more embodiments, the disclosure may be a cleaner, more reliable test method than hydrostatic testing on piping containment sumps. In one or more embodiments, the disclosure may include a digital pressure sensor with a sensitivity of 1/10 inches of water column that may be used to monitor pressure inside the containment being tested. In one or more embodiments, using a positive pressure method in conjunction with a vacuum or negative method may measure not only the tightness of the containment system, but also whether the leaks are going out into the environment as opposed to going back into the UST. In one or more embodiments, the disclosure may provide a containment testing device, system and/or method that may be portable and simple to operate, that may provide accurate measurements and detection of leaks, that may be use repeated, that may provide a relatively shorter test duration, that may be affordable.

Other aspects and advantages may be apparent from the following detailed description, the accompanying drawings, and/or the claims.

### BRIEF DESCRIPTION OF THE DRAWINGS

Various embodiments of the disclosure will now be discussed with reference to the appended drawings. It is appreciated that these drawings depict only typical embodiments of the disclosure and are not to be considered limiting of its scope.

FIG. 1 shows a sectional view of aspects of one embodiment of an underground storage tank (UST) system;

FIG. 2 is a top view of one embodiment of a spill containment cover and a spill containment ring that may be associated with a spill bucket;

FIG. 3 is a sectional view of aspects of one embodiment of a spill containment system;

FIG. 4 is a perspective view of one embodiment of a containment testing device;

FIG. 5 is a side view of the containment testing device illustrated in FIG. 4;

FIG. 6 is a bottom view of the containment testing device illustrated in FIG. 4;

FIG. 7 is a perspective view of another embodiment of a containment testing device;

FIG. 8 is a side view of the containment testing device illustrated in FIG. 7;

FIG. 9 is a bottom view of the containment testing device illustrated in FIG. 7;

FIG. 10 is a perspective view of the containment testing device illustrated in FIG. 4 including an inflatable seal member;

FIG. 11 is a side view of the containment testing device illustrated in FIG. 10;

FIG. 12 is a detailed side sectional view along line A-A of the containment testing device illustrated in FIG. 10 and a sectional view of aspects of a spill containment ring and a spill bucket;

FIG. 13 is a detailed side sectional view along line A-A of the containment testing device illustrated in FIG. 10 and a sectional view of aspects of a spill containment ring and a spill bucket, wherein the containment testing device is configured in an alternate position as compared to FIG. 12;

FIG. 14 is a perspective view of one embodiment of containment testing device including a first valve, a second valve and a third valve;

FIG. 15 is a top view of the containment testing device illustrated in FIG. 14;

FIG. 16 is a perspective view of one embodiment of a hose;

FIG. 17 is a perspective view of one embodiment of a vacuum source connecting unit;

FIG. 18 is a front view of one embodiment of a manometer;

FIG. 19 is a perspective view of the containment testing device illustrated in FIG. 10 situated respective to a spill containment system;

FIG. 20 is a top view of one embodiment of a spill containment ring and a containment testing device including an uninflated inflatable seal member;

FIG. 21 is a top view of the spill containment ring and the containment testing device illustrated in FIG. 20, albeit the inflatable seal member has been inflated;

FIG. 22 is a sectional view of one embodiment of aspects of a spill containment system wherein an inflatable plug has been install and inflated in a fill pipe;

FIG. 23 is a sectional view of one embodiment of aspects of a turbine sump system;

FIG. 24 is a perspective view of an alternate embodiment of containment testing device and a sectional view of aspects of the turbine sump system illustrated in FIG. 23;

FIG. 25 is a sectional view of one embodiment of a handle configured to receive a means for aiding in stabilizing and supporting the containment testing device 100 (such as a bolt);

FIG. 26 is a perspective view of the containment testing device of as illustrated in FIG. 24 with a support device operably connected to it, as well as a sectional view of a turbine sump system;

FIG. 27 is a perspective view of an alternate embodiment of a containment testing device;

FIG. 28 is a flow diagram that depicts one embodiment of a method for using a containment testing device in accordance with one embodiment;

FIG. 29 is a flow diagram that depicts one embodiment of another method for using a containment testing device in accordance with one embodiment; and

FIG. 30 is a flow diagram that depicts one embodiment of another method for using a containment testing device in accordance with one embodiment.

### DETAILED DESCRIPTION

The following description illustrates principles of the disclosure that may be applied in various ways to provide different embodiments. There may be many different forms of embodiments of the disclosure, and as such, embodiments should not be limited to those set forth herein and shown in the accompanying drawings. While exemplary embodiments of the disclosure may be shown and described herein, changes and modifications may be made without departing from its scope and concepts. That which is set forth herein and shown in the accompanying drawings is offered to illustrate the principles of the disclosure and not as limitations. Other variations of the disclosure may be included within the principles of the disclosure.

In some embodiments, the disclosure may be configurable, adaptable and customizable to meet the various needs of various users in various circumstances and/or to be compatible and/or used in conjunction with various systems, apparatuses, devices, means, methods and/or structures.

The disclosure may be configured in various ways, by various means and/or various methods, with various parts, to various dimensions (such as but limited to shapes, lengths, widths, heights, depths, and/or sizes) and/or with and/or from various materials, and/or any combinations thereof. The specific parts, materials, members, devices, systems and/or components of the disclosure may be configured together and/or separate and/or with other materials, members, devices, systems and/or components and/or any combinations thereof.

The drawings herein may but do not necessarily illustrate the disclosure to scale. The drawings herein may but do not necessarily depict the exact positions, shapes, sizes, layouts, designs, angles and/or other dimensions and/or configurations in which the disclosure may be implemented. In one or more embodiments, the components of the disclosures may be configured to various positions, shapes, sizes, layouts, designs, angles and/or other dimensions and/or configurations from various materials, for various reasons.

The disclosure may be used for various uses and/or for various purposes. For example, the disclosure may be used to test the tightness of spill buckets, sumps or other containment systems or units associated with underground storage tanks.

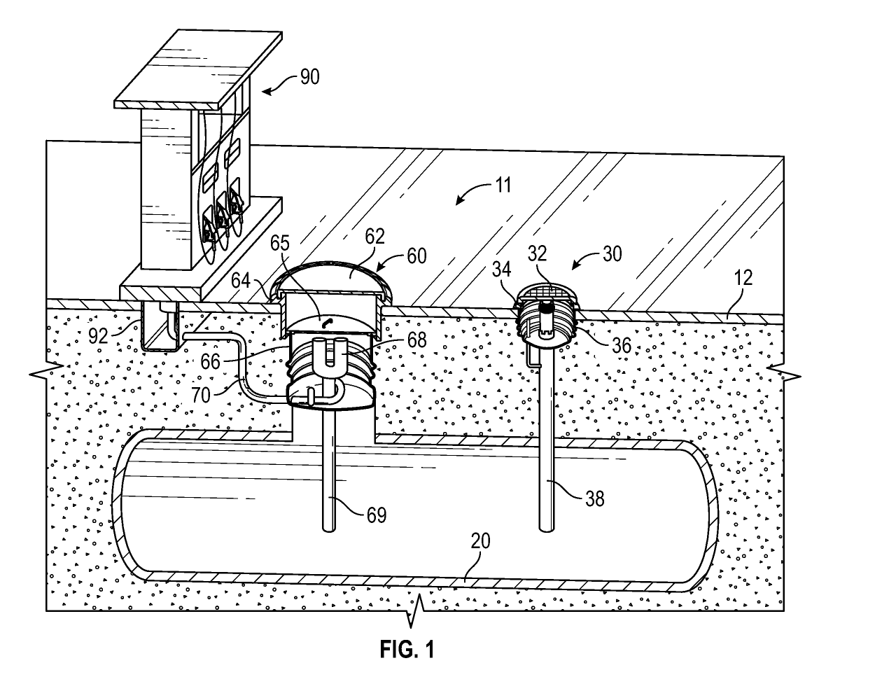

FIG. 1 shows a sectional view of one embodiment of an underground storage tank (UST) system 11 and ground 12. As shown in FIG. 1, UST system 11 may include a tank 20, a spill containment system 30, a turbine sump system 60, a fuel line 70 and a dispenser 90.

Tank 20 may be designed to house fuel and may include a single wall, a double wall or other walled or layered configuration made of various materials. Tank 20 may include other components, whether illustrated or described herein or not.

Spill containment system 30 may be designed to catch fuel that drips and spills over when a driver fills tank 20 and to prevent the captured fuel from contaminating the surrounding environment. Spill containment system 30 may include a spill containment cover 32, a spill containment ring 34, a spill bucket 36, a fill pipe 38 and other components discussed below. Although shown directly above tank 20, aspects of the spill containment system 30 may be located in an alternative position in respect to tank 20. Spill containment system 30 may include other components, whether illustrated or described herein or not.

Turbine sump system 60 may be designed to pump fuel from tank 20 to dispenser 90 where fuel can be distributed to consumers. Turbine sump system 60 may include a turbine sump access cover 62, a turbine sump ring 64, a turbine sump containment cover 65, a turbine sump containment 66, a turbine pump 68, and a pipe 69. Turbine sump system 60 may include other components, whether illustrated or described herein or not. For example, turbine sump system 60 may include test boots, flex connectors, leak detection systems and sensors, pipes, etc.

Dispenser 90 may include a dispenser sump 92 and other components (such as nozzles, hoses, meters, etc.) whether illustrated or described herein or not.

The UST system 11 may include other components and/or various containment systems, whether illustrated or described herein or not. For instance, UST system 11 may include monitoring systems, sensors, vents, vapor recovery systems, vacuum systems, piping, wiring, transition/intermediate sumps, leak detector systems, seals, hoses, conduits, electronics, fittings, connectors, etc.

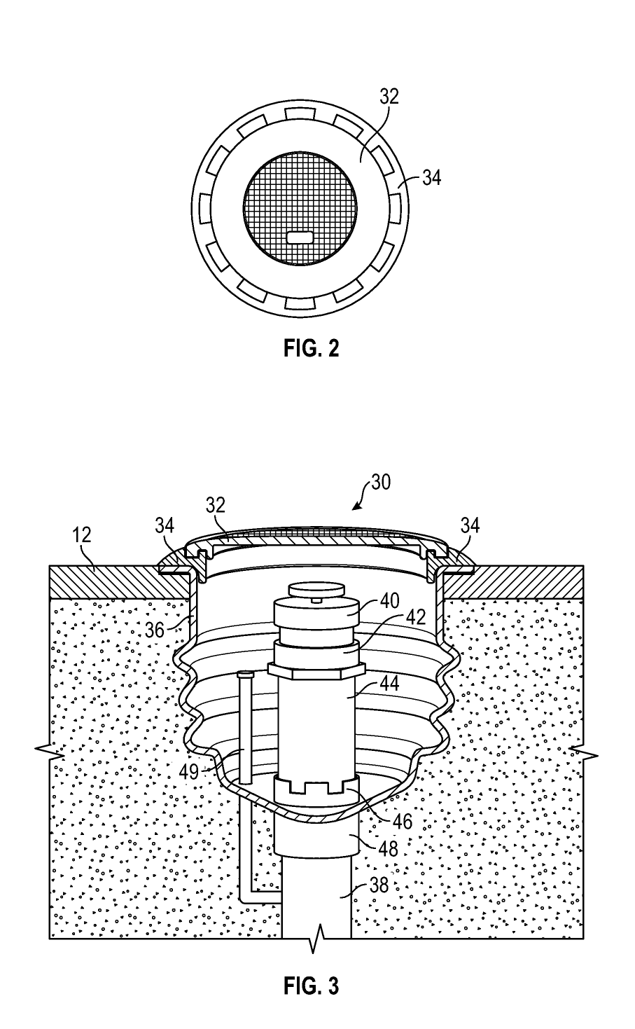

FIG. 2 shows a top view of one embodiment of spill containment cover 32 and spill containment ring 34 associated with spill bucket 36. Spill containment cover 32 may be designed to withstand vehicles travelling over it. Spill containment ring 34 may assume various configurations and be made from various materials. For example, spill containment ring 34 may be made from cast iron capable of being run over by vehicles and of being subjected to various weather conditions. Spill containment ring 34 may retain spill containment cover 32 and be attached to spill bucket 36.

FIG. 3 shows a sectional view of one embodiment of spill containment system 30. Spill bucket 36 may range in size, such as from about 5 gallons to about 25 gallons. FIG. 3 shows aspects of one embodiment of spill containment cover 32, spill containment ring 34, spill bucket 36, and fill pipe 38. The various components of spill containment system 30 may be configured to various sizes. For example, spill containment cover 32, spill containment ring 34, and/or spill bucket 36 may range in size, such as from about 9 inches to about 24 inches in diameter. Spill bucket 36 may be configured within larger sumps and/or in conjunction with other systems, such as, vapor recovery systems. In such instances, spill bucket 36 may be accessed via a separate cover or lid. Although spill bucket 36 illustrated in FIG. 3 is in a single wall configuration, spill bucket 36 may be other configurations such as a double walled corrugated configuration or other configurations. FIG. 3 also shows one embodiment of spill containment system 30 that may include a snap cap 40, a fill adapter 42, a nipple 44, first threads 46, second threads 48, and a drain 49. In one or more embodiments, snap cap 40 may be configured in some other configuration than a snap cap configuration. Although not shown in FIG. 3, a drop tube may be housed within fill pipe 38 and extend to fill adapter 42. Snap cap 40, fill adapter 42, nipple 44, first threads 46, second threads 48, and drain 49 may assume various configurations and be made from various materials. For example, fill adapter 42 may be designed as a tight fill adapter that allows a driver to attach his or her hose to it in order to fill tank 20 with fuel. In one or more embodiments, nipple 44 may be a 4-inch steel pipe nipple that attaches to fill adapter 42 and first threads 46. In one or more embodiments, first threads 46 may be configured to receive nipple 44 and may be a 4-inch thread (or whatever size nipple 44 is). In one or more embodiments, second threads 48 may be attached to fill pipe 38 and spill bucket 36. In one embodiment, drain 49 may be actuated by stepping on it to allow spilled fuel to enter into fill pipe 38.

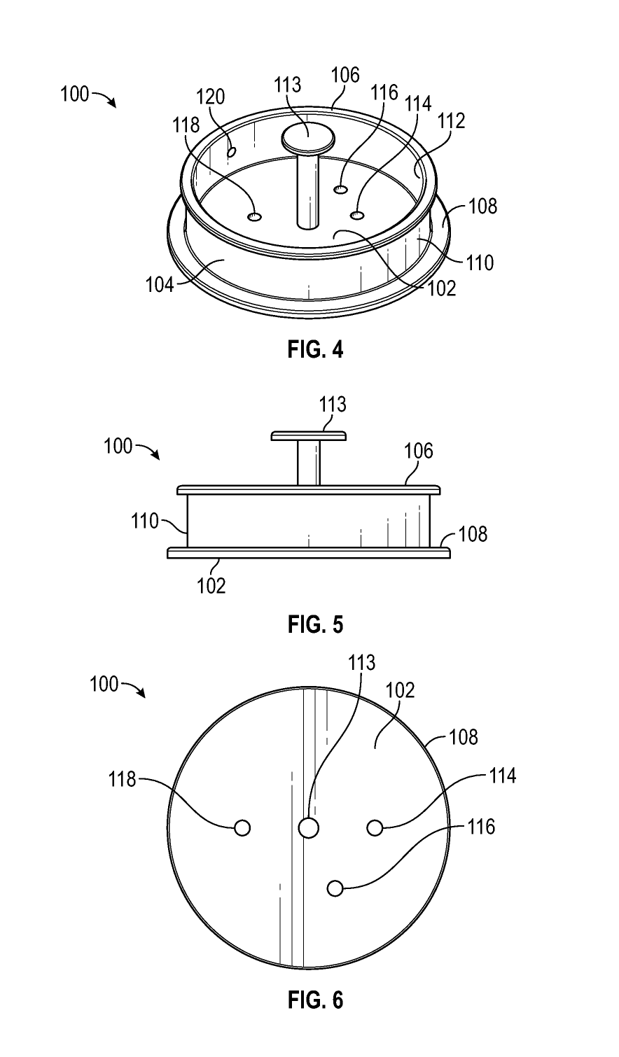

FIG. 4 shows a perspective view of one embodiment of a containment testing device 100 which may be designed for testing the tightness of various containment systems such as spill containment systems (such as spill containment system 30), turbine sump containments (such as turbine sump system 60), dispenser sump containments, vapor recovery containments, transitional/intermediate sump containments, and/or other containment systems.

Although containment testing device 100 is shown in FIG. 4 in a substantially circular shape, in one or more embodiments, containment testing device 100 may be configured in an oval, square, rectangular or any other shape to match the shape of various containment systems. In one or more embodiments, containment testing device 100 may include a base portion 102, a wall portion 104, first ledge portion 106, and second ledge portion 108. Wall portion 104 may include an exterior surface 110 and an interior surface 112. As shown in FIG. 4, containment testing device 100 may include a handle 113 and various ports or openings. For example, containment testing device 100 may include a first port 114, a second port 116, a third port 118 and/or a fourth port 120. The purpose of these ports or openings will be discussed below.

In one or more embodiments, containment testing device 100 and its components may be made from various materials. For example, containment testing device 100 and/or its components may be made from metals (such as silver, gold, europium, neptunium, cobalt, iron, copper, nickel, lead, lithium, calcium, titanium, tin, etc.), non-metals (such as carbon, sulfur, chlorine, argon, etc.), metalloids (such as boron, tellurium, etc.), ceramics (such as alumina, silicon, tungsten, granite, limestone, marble, slate, quartzite, etc.), polymers and plastics (such as natural rubbers, synthetic rubbers, polyvinyl chloride (PVC), PC, high density polyethylene (HDPE), oriented or stretch blown polyethylene terephthalate (PET), polypropylene (PP), acrylonitrile butadiene styrene (ABS), polycarbonate, etc.), alloys (such as alloys of aluminum, copper, gold, silver, iron, lead, titanium, etc.), woods and natural products (such as hickory, aspen, maple, etc.), and/or the like and/or other materials and/or combinations thereof. In one or more embodiments, at least some aspects of containment testing device 100 may be made from billet aluminum, such as from aluminum that is 2 and ½ inches thick. The materials from which containment testing device 100 is made may have various characteristics, such as water resistant, heat resistant, pressure resistant and/or other characteristics. In one or more embodiments, the material may be capable of withstanding pressure and resist breakage or buckling. In one or more embodiments, the material may be transparent. For example, aspects of base portion 102 may be made from transparent material that may enable a user to look through it to observe the condition of the containment system being tested and/or to look for leaks visible during the testing process. In one or more embodiments, the material may be light weight.

In one or more embodiments, containment testing device 100 may assume various designs so that it may test containment systems of various sizes, including various sized spill containment covers, spill containment rings, and spill buckets. For example, in one or more embodiments, base portion 102 may vary in size, such as being about 6 inches to about 23 inches in diameter (such as about 10.75 inches in diameter). In one or more embodiments, exterior surface 110 may vary in size, such as being about 1 inch to about 6 inches in height (such as about 2.00 inches in height). In one or more embodiments, as the height of exterior surface 110 increases, the greater may be the height of the inflatable seal member 122 and as the height of the inflatable seal member 122 increases, the wider the distance that the inflatable seal member 122 may expand. In one or more embodiments, first ledge portion 106 may vary in size (such as being about ½ of an inch in width) and may extend beyond exterior surface 110. In one or more embodiments, second ledge portion 108 may vary in size and configuration. For example, second ledge portion 108 may extend beyond exterior surface 110 at a greater length than first ledge portion 106 extends beyond exterior surface 110 (see FIG. 5). In one or more embodiments, first ledge portion 106 extend beyond exterior surface 110 at a greater length than second ledge portion 108 extends beyond exterior surface 110 (see FIG. 8). In one or more embodiments, the circumference of the profile of the interior surface 112 may vary, such as being about 6 inches to about 23 inches in diameter (such as about 8.75 inches in diameter). In one or more embodiments, handle 113 may assume various configurations. For example, handle 113 may be about 4.00 inches long and 0.75 inches wide and include a platform 115 for handling. In one or more embodiments, the platform 115 may vary in size, such as being about ¼ of an inch in diameter to about 6 inches in diameter (such as about 2.00 inches in diameter) and about 0.25 inches in thickness, more or less.

FIG. 5 is a side view of the containment testing device 100 illustrated in FIG. 4 including base portion 102, exterior surface 110 of wall portion 104, first ledge portion 106, second ledge portion 108, and handle 113. FIG. 5 shows second ledge portion 108 extending beyond exterior surface 110 at a greater length than first ledge portion 106 extends beyond exterior surface 110. Such configuration may aid in the installation of the inflatable seal member 122 and/to aid in holding an inflatable seal backer of the inflatable seal member 122 if provided.

FIG. 6 is a bottom view of the containment testing device 100 illustrated in FIG. 4 including base portion 102, second ledge portion 108, components of handle 113, first port 114, second port 116, and third port 118. FIG. 6 shows second ledge portion 108 as part of base portion 102. In one or more embodiments, second ledge portion 108 may be separate from base portion 102.

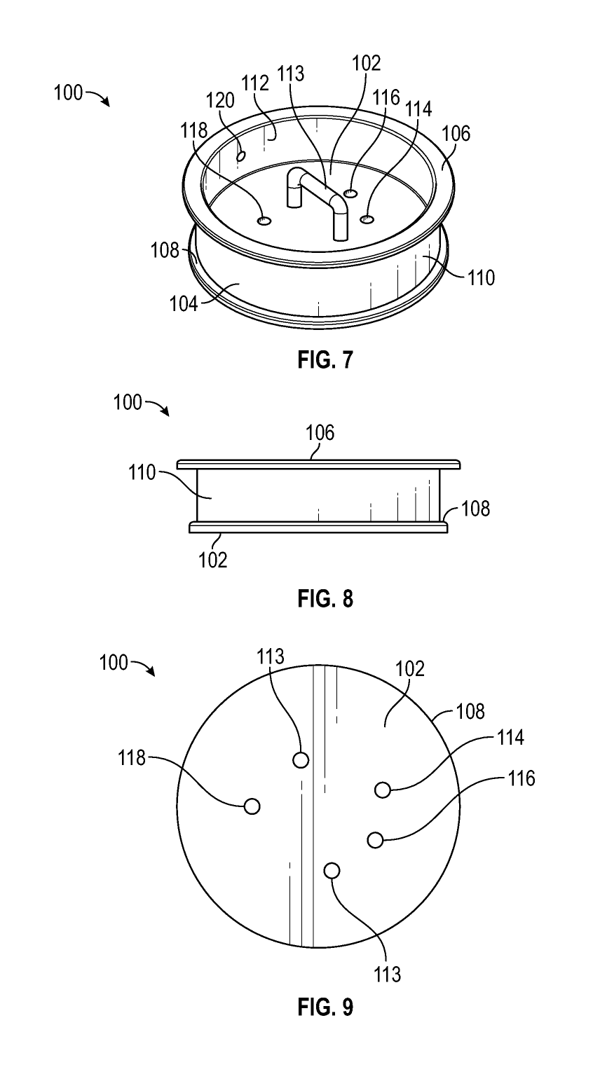

FIG. 7 shows a perspective view of another embodiment of containment testing device 100 for testing the tightness of spill containment systems (such as spill containment system 30), sump systems (such as turbine sump system 60) and/or other containment systems. Like the embodiment of FIG. 4, the embodiment of the containment testing device 100 illustrated in FIG. 7 may include base portion 102, wall portion 104, first ledge portion 106, second ledge portion 108, and wall portion 104 which may include exterior surface 110 and interior surface 112. However, as shown in FIG. 7, the length of the portion of the first ledge portion 106 that extends beyond the exterior surface 110 of wall portion 104 may assume a greater length than the length of the portion of the second ledge portion 108 that extends beyond the exterior surface 110 of wall portion 104. Such configuration may allow containment testing device 100 to fit into narrower containment systems and/or provide additional structural support. Such configuration may provide additional support for the inflatable seal to help keep it from rolling off of the containment testing device 100 while under vacuum. Such configuration may allow the bottom of the containment testing device 100 to fit into smaller diameter containments systems.

In addition, containment testing device 100 may include different forms of handle 113, such as shown in FIG. 7. Like the embodiment shown in FIG. 4, the embodiment of containment testing device 100 in FIG. 7 may include various ports or openings, such as, first port 114, second port 116, third port 118 and fourth port 120.

FIG. 8 is a side view of the containment testing device 100 illustrated in FIG. 7 including base portion 102, exterior surface 110 of wall portion 104, first ledge portion 106, and second ledge portion 108. FIG. 8 shows first ledge portion 106 extending beyond exterior surface 110 at a greater length than second ledge portion 108 extends beyond exterior surface 110.

FIG. 9 is a bottom view of the containment testing device 100 illustrated in FIG. 7 including base portion 102, second ledge portion 108, components of handle 113, first port 114, second port 116, and third port 118. FIG. 9 shows second ledge portion 108 as part of base portion 102. Like the embodiment illustrated in FIG. 6, the embodiment of second ledge portion 108 illustrated in FIG. 9 may be separate from base portion 102.

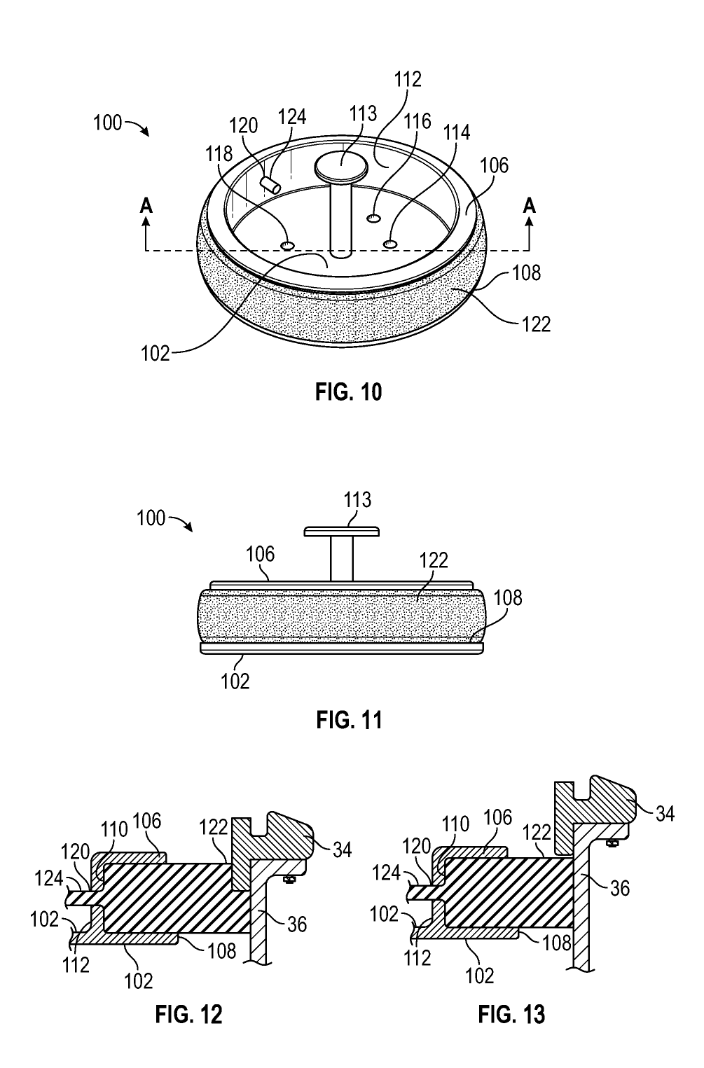

FIG. 10 is a perspective view of the containment testing device 100 illustrated in FIG. 4 including an inflatable seal member 122 that may be expanded in order to provide a temporary seal between the containment testing device 100 and a targeted containment system. Although not shown, the containment testing device 100 illustrated in FIG. 7 and other embodiments of containment testing device 100 may also include an inflatable seal member 122. Inflatable seal member 122, once properly inflated, may provide a positive seal of containment testing device 100 to a target containment system. In one or more embodiments, inflatable seal member 122 may be pneumatically expanded. As shown in FIG. 10, in one or more embodiments, inflatable seal member 122 may be situated between first ledge portion 106 and second ledge portion 108. Inflatable seal member 122 may be designed to various configurations and made of various durable inflatable materials so that it may be expanded and contracted. For example, inflatable seal member 122 may made from rubber, plastic, Nylon, Nomex®, Dacron®, Kevlar® or other materials, such as Pawling Engineered Product's Pneuma-Seal® inflatable seal which may “be configured to practically any shape or size” and various configurations such as Pneuma-Seal Type 1, Pneuma-Seal Type 2, Pneuma-Seal Type 7, Pneuma-Seal Type 10 and/or “continuous loops for axial or radial expansion, in strip form with specially sealed ends, in ‘U’ or similar shapes with preformed corners, or as axially expanding rectangles” (Pawling Engineered Product's website http://www.pawlingep.com/products/pneuma-seal, accessed Jul. 30, 2016). The material used to make the inflatable seal member 122 may include various characteristics, such as, for example, it may include a molded fabric-reinforced seal to provide added structural integrity; it may include an extruded inflatable profile; and/or it may be smooth, serrated, racetrack, rectangular, square, beaded, flat, channeled, angled, mesa topped, and/or other profile types.

In one or more embodiments, inflatable seal member 122 may include a fill line 124 situated through fourth port 120 for filling the inflatable seal member 122 with air or liquids or other materials. Fill line 124 may be disposed in various configurations and made from various materials. For example, fill line 124 may be part of inflatable seal member 122 and/or a hose, a fitting, a valve or other device operably connected to inflatable seal member 122. A user may inflate inflatable seal member 122 by attaching fill line 124 to a compressor and allowing the compressor to inflate inflatable seal member 122. In one or more embodiments, the inflatable seal member 122 may be able to be inflated to whatever pressure is necessary to form a positive seal (such as up to about 50 psi) or up to burst pressure. Fill line 124 may be configured to be any desirable length, such as, for example, about 8 inches long, or more or less.

FIG. 11 is a side view of the containment testing device 100 illustrated in FIG. 10.

FIG. 12 is a detailed side sectional view along plane A-A of the containment testing device 100 illustrated in FIG. 10. FIG. 12 also shows a sectional view of aspects of spill containment ring 34 and spill bucket 36. As shown in FIG. 12, inflatable seal member 122 may form a positive seal against spill containment ring 34 and aspects of spill bucket's 36 inner wall. FIG. 12 shows containment testing device 100 including exterior surface 110, interior surface 112, first ledge portion 106, second ledge portion 108, base portion 102, and inflatable seal member 122 with fill line 124.

As shown FIG. 12, inflatable seal member 122 may be situated between first ledge portion 106 and second ledge portion 108 such that as inflatable seal member 122 is inflated first ledge portion 106 and second ledge portion 108 may channel the expansion of inflatable seal member 122 away from exterior surface 110 and towards the targeted containment system. Such configuration, may aid containment testing device 100 in remaining in proper position as and/or once inflatable seal member 122 forms a seal against the targeted containment system. Although not shown in FIG. 12, the expansion of inflatable seal member 122 may be accomplished by the various means and devices, whether illustrated or described herein or not.

FIG. 13 is a detailed side sectional view along line A-A of the containment testing device 100 illustrated in FIG. 10. FIG. 13 also shows a sectional view of aspects of spill containment ring 34 and spill bucket 36. As shown in FIG. 13, inflatable seal member 122 may form a positive seal against aspects of spill bucket's 36 inner wall.

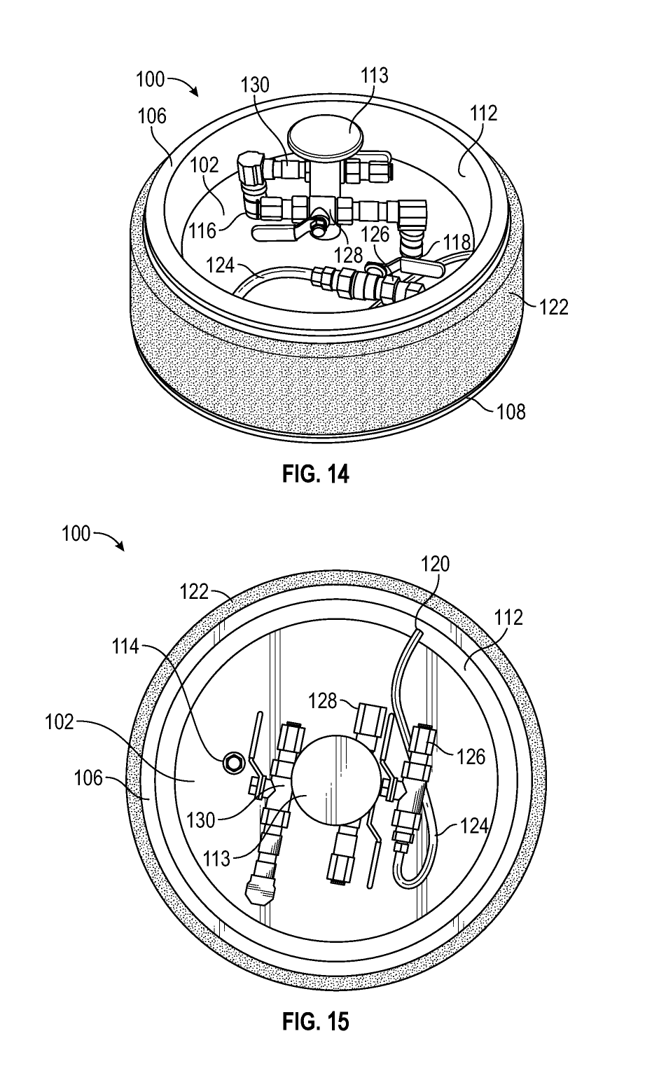

FIG. 14 is a perspective view of the containment testing device 100 illustrated in FIG. 10 including a first valve 126, a second valve 128 and a third valve 130. First valve 126, second valve 128 and third valve 130 may be made from various materials to various configurations. For example, one or more of first valve 126, second valve 128 and third valve 130 may include a quick connect air fitting (such as a Parker quick connect ¼ dry break air fitting).

In one or more embodiments, first valve 126 may be operably connected to fill line 124 (such as, for example, via a barbed fitting). First valve 126 may be operably connected to a compressor to enable a user to inflate the inflatable seal member 122 and control the flow of air or liquids. For example, a user may operably connect first valve 126 to a compressor, activate the compressor and inflate inflatable seal member 122 to the desired level, and then articulate first valve's 126 handle to stop the inflation and retain the level of pressure inside the inflate inflatable seal member 122 (and thereby retain containment testing device's 100 temporary seal to the targeted containment system). Once the testing is completed, the user may articulate the first valve's 126 handle, release the pressure and remove the containment testing device 100 from the targeted containment system.

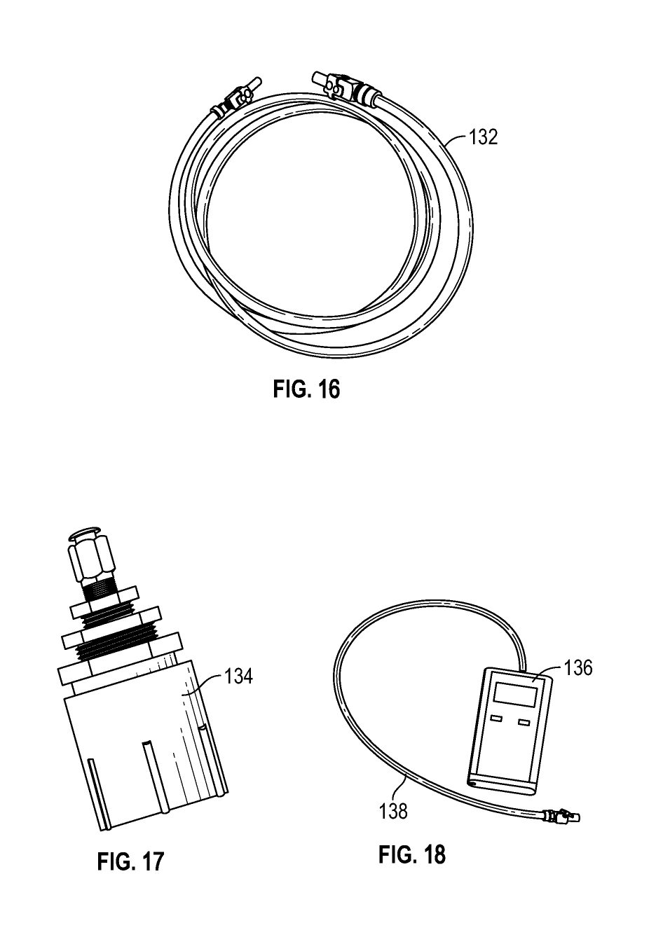

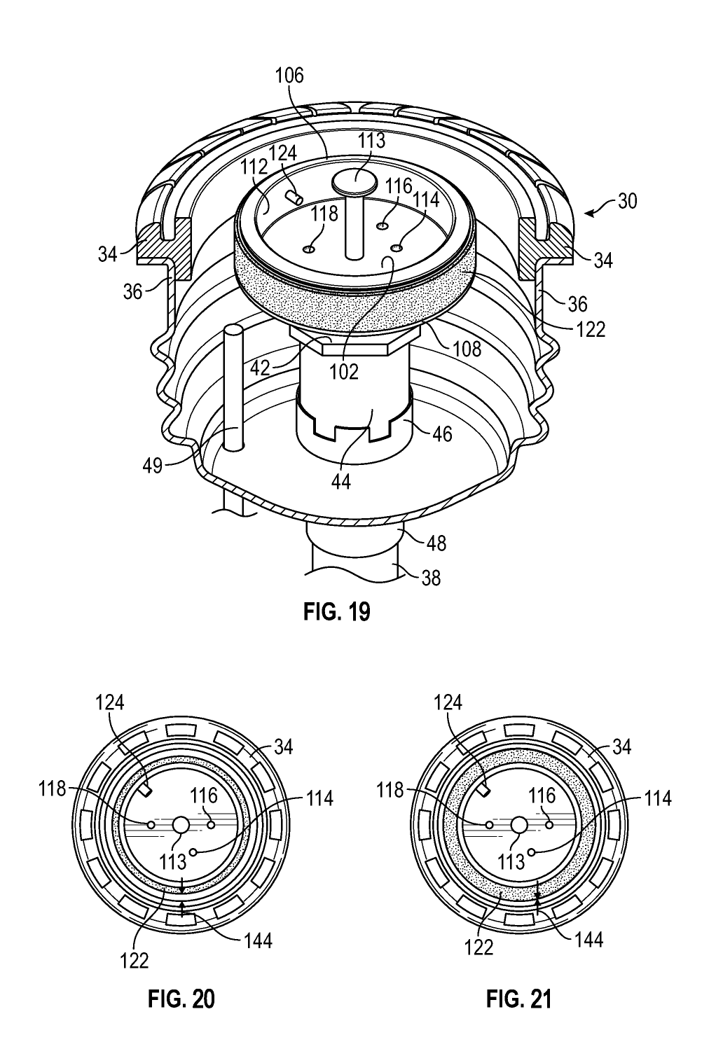

In one or more embodiments, second valve 128 and third valve 130 may be operably connected to first port 114, second port 116 and/or third port 118. Second valve 128 and third valve 130 may enable a user to supply and regulate positive and/or negative pressure into the targeted containment system and/or to enable a user to monitor the level of pressure in the targeted containment system. For example, second valve 128 and/or third valve 130 may be operably connected to a hose 132 (such as the hose illustrated in FIG. 16) which hose 132 may be operably connected to a vacuum source connecting unit 134 (such as the vacuum source connecting unit illustrated in FIG. 17). Vacuum source connecting unit 134 may be operability connected to a compressor or other positive pressure source to enable a user to supply and regulate positive pressure into the targeted containment system. Alternatively and/or in addition, vacuum source connecting unit 134 may be operability connected to a vacuum source to enable a user to supply and regulate negative pressure into the targeted containment system. In one or more embodiments, second valve 128 and/or third valve 130 may be operably connected to a manometer 136 (such as, for example, the manometer illustrated in FIG. 18 via hose 138 or some other means such as a PSI gauge) to enable a user to monitor the level of pressure in the targeted containment system.

FIG. 15 is a top view of the containment testing device 100 illustrated in FIG. 14. As shown in FIG. 15, first valve 126 may be operably connected to fill line 124 situated through fourth port 120, second valve 128 may be operably connected to third port 118 (not shown), third valve 130 may be operably connected to second port 116 (not shown), and first port 114 may be plugged.

Although not shown, a safety pressure release valve or system may be operably connected to and/or through first port 114, second port 116, third port 118 and/or another port or means and may provide a release when pressure reaches a certain level within the targeted containment system. Although not shown, in one or more embodiments, an inspection camera system may be operably connected to and/or through first port 114, second port 116, third port 118 and/or another port or means and may provide a user the ability to digitally visualize conditions and/or look for leaks. For example, in one or more embodiments, the inspection camera system may include a fiber optic camera may be included in the containment testing device 100. In one or more embodiments, the camera system may include a borescope system which may be operably connected to and/or through first port 114, second port 116, third port 118 and/or another port or means and may provide a user the ability to maneuver the scope around the containment system to visualize, listen and/or identify the conditions and/or leaks. In one or more embodiments, a user may operate the inspection camera system through the base portion 102 while the containment testing device 100 has been installed and/or while testing the targeted containment system to check for leaks and/or other conditions.

Although not shown, in one or more embodiments, a microphone system may be operably connected to and/or through first port 114, second port 116, third port 118 and/or another port or means and may provide a user the ability to listen to conditions and/or for leaks.

Although not shown, in one or more embodiments, a user may employ positive pressure to the containment system using a trace gas (such as helium and/or another trace gas). In one or more embodiments, a helium detector (and/or another trace gas detector) may be used to find traces of helium in the backfill surrounding the targeted containment system. Such a method used in conjunction with applying negative pressure or a vacuum methodology, may allow a user to determine the tightness of the targeted containment system and to determine whether leaks from the targeted containment system are or are not going out into the environment.

Alternatively and/or in addition, a user may look through a base portion 102 that is configured with transparent material to check for leaks and/or other conditions. In one or more embodiments, the containment testing device 100 may include a combination of an inspection camera system, a microphone system, trace gas and trace gas detector and/or other means or tools.

FIG. 16 shows one embodiment of hose 132. Hose 132 may assume various configurations and be made from various materials. For example, hose 132 may be between about 1/16 of an inch to about 2 inches in diameter (such as ¼ of an inch); hose 132 may be made from plastic, rubber and/or any other material which may facilitate and/or enable containment testing device 100 to operably connect to a pressure source. Alternatively and/or in addition, something other than a hose may be used to facilitate and/or enable containment testing device 100 to operably connect to a pressure source.

FIG. 17 shows one embodiment of vacuum source connecting unit 134 which may be operability connected to a compressor or other positive pressure source to enable a user to supply and regulate positive pressure into the targeted containment system. Alternatively and/or in addition, vacuum source connecting unit 134 may be operability connected to a vacuum source to enable a user to supply and regulate negative pressure into the targeted containment system. Vacuum source connecting unit 134 may assume various configurations and be made from various materials. For example, vacuum source connecting unit 134 may be made from rubber, PVC, steel and/or any other material that may facilitate and/or enable containment testing device 100 to operably connect to a pressure source. In one or more embodiments, the connections/fittings, which may be associated with the various hoses (such as hose 132) and vacuum source connecting units (such as vacuum source connecting unit 134) and other components of the containment testing device 100, may include quick release functionality for easily assembling and dissembling the same.

FIG. 18 is a front view of one embodiment of manometer 136 that may be operably connected to containment testing device 100 in order to enable a user to monitor the level of pressure in the targeted containment system. As noted above, manometer 136 may be operably connected to containment testing device 100 via hose 138 or some other means.

Although not shown in the figures herein, in one or more embodiments, containment testing device 100 may include other components such as hoses, piping, clamps, fittings, valves, barbs, bushings, ties, nozzles, tubing, holes, nuts, bolts, and the like and other materials and/or combinations thereof, whether illustrated or described herein or not.

FIG. 19 is a perspective view of the containment testing device 100 illustrated in FIG. 10 and a perspective sectional view of aspects of spill containment system 30. In FIG. 19, spill containment cover 32 has been removed and the containment testing device 100 has been placed proximal to the inner wall of the spill containment ring 34 associated with spill bucket 36. Although FIG. 19 shows containment testing device 100 proximal to the inner wall of the spill containment ring 34, in one or more embodiments, the position of containment testing device 100 may be adapted to the particular configuration of the targeted containment system. The flexibility of containment testing device's 100 inflatable seal member 122 allows it to be adaptable to various surfaces and designs. In one or more embodiments, containment testing device 100 may form a positive seal against the inner walls of a spill bucket and/or spill containment ring (see FIGS. 12 and 13). For example, FIG. 12 shows inflatable seal member 122 forming a positive seal against aspects of spill containment ring 34 and aspects of spill bucket's 36 inner wall. FIG. 13 shows inflatable seal member 122 forming a positive seal against aspects of spill bucket's 36 inner wall. Although not shown in FIG. 12 or 13, inflatable seal member 122 may form a positive seal against spill containment ring 34.

Although not shown in FIG. 19, in one or more embodiments, other and/or additional actions may occur besides, in addition to, and/or before placing containment testing device 100 proximal to the inner wall of the spill containment ring 34 associated with spill bucket 36 (for example, snap cap 40 may have been removed, an inflatable plug may have been inserted into fill pipe 38, etc.). Although not shown in FIG. 19, means for inflating inflatable seal member 122, means for providing a positive and/or negative pressure source(s) (such as, for example a compressor and/or vacuum source), means for providing a pressure monitoring device, and/or other devices or means may be configured to the containment testing device 100 for various reasons. Although FIG. 19 shows one embodiment of spill containment system 30 configured in a particular way, containment testing device 100 may be designed to be adaptable to form a seal with differently designed containment systems.

FIG. 20 is a top view of one embodiment of a containment testing device 100 with an uninflated inflatable seal member 122 and a spill containment ring 34 wherein a spill containment cover 32 has been removed and the containment testing device 100 has been placed proximal to the spill containment ring 34. FIG. 20 shows that because the inflatable seal member 122 has not yet been inflated to form a positive seal, a space 144 exists between inflatable seal member 122 and the spill containment ring 34.

FIG. 21 is a top view of the containment testing device 100 and the spill containment ring 34 of FIG. 20 except that the inflatable seal member 122 has been inflated to form a positive seal and to eliminate and/or reduce space 144.

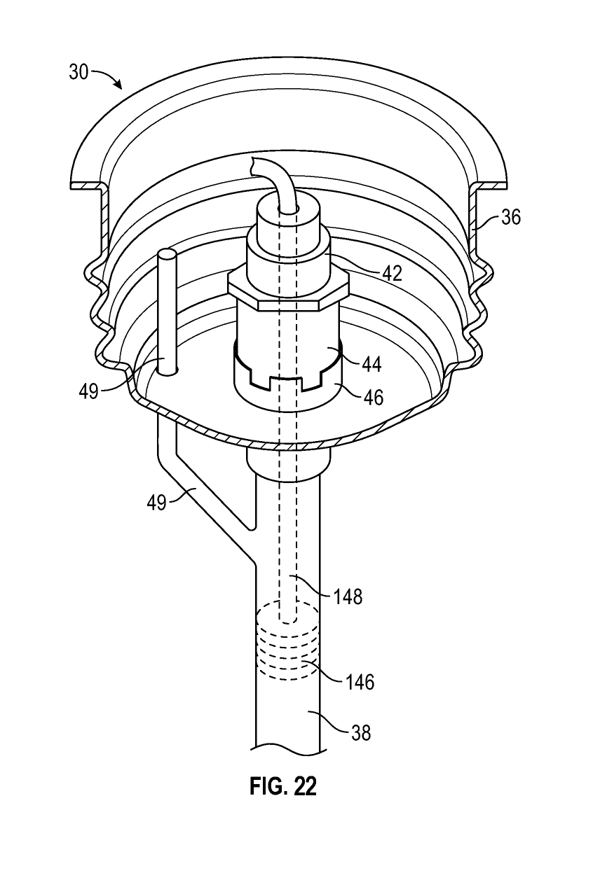

FIG. 22 shows a sectional view of one embodiment of aspects of spill containment system 30 wherein snap cap 40 has been removed and inflatable plug 146 (operably connected to a hose 148) has been install and inflated below drain's 49 opening in fill pipe 38 in order to isolate tank 20 from the targeted containment system (such as spill containment system 30). In one or more embodiments, alternative and/or additional devices may be used to isolate tank 20 from the targeted containment system. For example, a cap 150 and a hose clamp 152 may be secured to fill adapter 42 in order to isolate tank 20 from the targeted containment system. In one or more embodiments, snap cap 40 may be removed and then cap 150 and hose clamp 152 may be secured to fill adapter 42.

In one or more embodiments, containment testing device 100 and none or at least one of the following may be provided in a kit for consumers to purchase: hose 132, vacuum source connecting unit 134, manometer 136, hose 138, inflatable plug 146, hose 148, cap 150, hose clamp 152 and/or other tools related to testing the tightness of a target containment system. In one or more embodiments, each, some and/or all of the following may be manufactured and/or sold separately and/or together: containment testing device 100, hose 132, vacuum source connecting unit 134, manometer 136, hose 138, inflatable plug 146, hose 148, cap 150, hose clamp 152 and/or other tools related to testing the tightness of a target containment system. If sold in a kit and/or together, in one or more embodiments, said items may be arranged and/or provided in a tool box, tool bag, carrying case and/or other easily portable means.

In one or more embodiments, containment testing device 100 may be designed so that it may test turbine sump systems of various sizes, including various sized turbine sump access covers, turbine sump rings, turbine sump containment covers and turbine sump containments. For example, in one or more embodiments, base portion 102 may vary in size, such as about 18 inches to about 60 inches in diameter. In one or more embodiments, exterior surface 110 may vary in size, such as about 3 inches to about 10 inches in height. As with previously stated embodiments, as the height of exterior surface 110 increases, the greater may be the height of the inflatable seal member 122 and as the height of the inflatable seal member 122 increases, the wider the distance that the inflatable seal member 122 may expand.

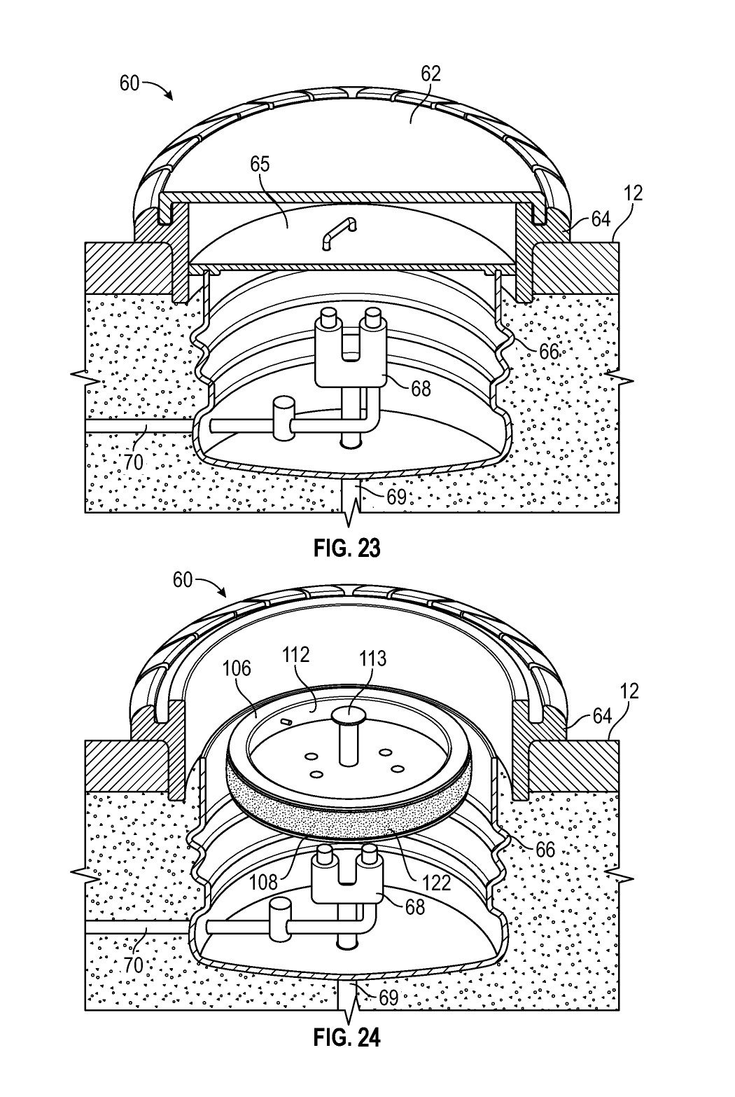

FIG. 23 shows a sectional view of one embodiment of aspects of turbine sump system 60. As indicated above, turbine sump system 60 may include turbine sump access cover 62, turbine sump ring 64, turbine sump containment cover 65, turbine sump containment 66, turbine pump 68, and pipe 69. The various components of turbine sump system 60 may be configured to various sizes. For example, turbine sump access cover 62, turbine sump ring 64, turbine sump containment cover 65 and/or turbine sump containment 66 may range in sizes, such as from about 18 inches to about 60 inches in diameter. Although the turbine sump system illustrated in FIG. 23 is in a single wall configuration, turbine sump system 60 may assume other configurations such as a double walled corrugated or other configuration. Turbine sump access cover 62 and turbine sump ring 64 may be designed to withstand vehicles travelling over them. Turbine sump access cover 62 and turbine sump ring 64 may assume various configurations and be made from various materials. For example, turbine sump ring 64 may be made from cast iron capable of being run over by vehicles and of being subjected to various weather conditions. Turbine sump ring 64 may retain turbine sump access cover 62.

FIG. 24 is a perspective view of one embodiment of containment testing device 100 and a perspective sectional view of aspects of turbine sump system 60. In FIG. 24, turbine sump access cover 62 and turbine sump containment cover 65 have been removed and the containment testing device 100 has been placed proximal to the inner wall of turbine sump containment 66. Although FIG. 24 shows containment testing device 100 proximal to the inner wall of turbine sump containment 66, in one or more embodiments, the position of containment testing device 100 may be adapted to the particular configuration of the targeted containment system. The flexibility of containment testing device's 100 inflatable seal member 122 allows it to be adaptable to various surfaces and designs. In one or more embodiments, containment testing device 100 may form a positive seal against the inner walls of turbine sump containment 66 and/or turbine sump ring 64 (similar to what is shown and described in relation to FIGS. 12 and 13 in relations to spill bucket 30). Although not shown in FIG. 24, means for inflating inflatable seal member 122, means for providing a positive and/or negative pressure source(s) (such as, for example a compressor and/or vacuum source), means for providing a pressure monitoring device, and/or other devices and means may be configured to the containment testing device 100 for various reasons. Although FIG. 24 shows one embodiment of turbine sump system 60 configured in a particular way, in one or more embodiments, containment testing device 100 may be designed to be adaptable to form a seal with differently designed turbine sump systems.

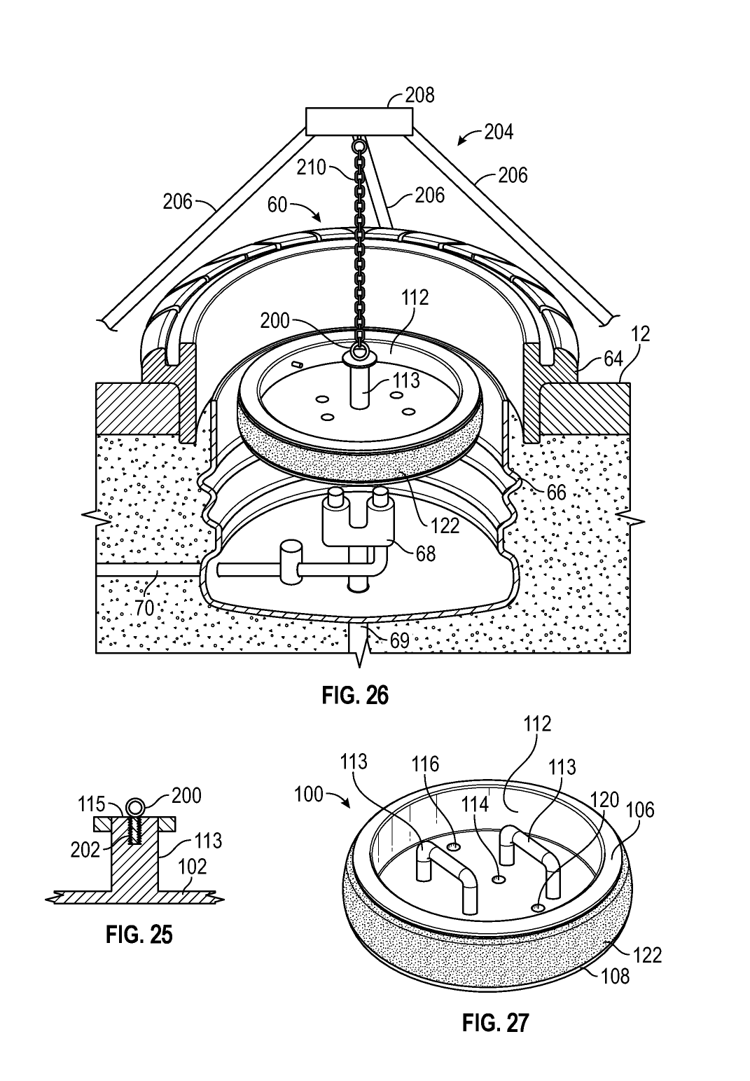

FIG. 25 is a sectional view of one embodiment of handle 113, base portion 102 and a bolt 200. In one or more embodiments, containment testing device 100 may assume various configurations and/or various things may be disposed within or on, used in conjunction with, or operably attached to containment testing device 100 to stabilize and support it during operation. For example, as shown in FIG. 25, handle 113 may be configured with a threaded channel 202 wherein bolt 200 may be inserted. Bolt 200 may assume various configurations including, for example, as shown in FIG. 25, bolt 200 may be configured as an eye bolt. Other configurations of bolt 200 may include U-bolt, J-bolts, Eye Lags, clevis, etc. In one or more embodiments, handle 113 may be configured to receive a support line connector or other means for stabilizing and supporting the containment testing device 100.

FIG. 26 is a perspective view of one embodiment of containment testing device 100 including the handle 113 as illustrated in FIG. 25, and a sectional view of the turbine sump system 60 as illustrated in FIG. 24. As shown in FIG. 26, a support device 204 may be operably connected to the containment testing device 100. Support device 204 may assume various configurations, including, for example, as shown in FIG. 26, a tripod configuration with three legs 206 and a base 208. A chain 210 may operably connect the support device 204 to the containment testing device 100. In one or more embodiments, some other means beside or in addition to chain 210 may be used to operably connect support device 204 to some aspect of the containment testing device 100 (such as a cable, wire, rope, stiff pipe, piece of metal, wood, plastic, etc.). Configuring support device 204 to provide support and stabilization from a substantially vertical position (such as via chain 210 and said tripod configuration which are situation superior to the containment testing device 100) may allow support means 204 and chain 210 or other means to adjust to containment systems of various burial depths and sizes. Such configuration may make it easy to lower the containment testing device 100 into position and to move between different targeted containment systems.

In one or more embodiments, some reasons for using support device 204 may be to reduce movement of containment testing device 100 during operation, reduce deflection or dropping of containment testing device 100 when negative pressure is applied, reduce rising of containment testing device 100 when positive pressure is applied, to allow an operator to more easily maneuver containment testing device 100 into proper position, and/or to otherwise support and/or stabilize containment testing device 100 during operation. In one or more embodiments, support device 204 may support between about 100 pounds to about 5000 pounds of total force (such as up to 2000 pounds of total force) without collapsing. In one or more embodiment, a user may operably attach support device 204 to containment testing device 100 before, during and/or after inflatable seal member 122 has been inflated.

Although not shown in FIG. 26, in one or more embodiments, support device 204 may include a bumper, side or lift arm used to stabilize and support the containment testing device 100 during operation. Although not shown in FIG. 26, in one or more embodiments, chain 210 or some other means could be operable connected to handle 113 without use of bolt 200. Although not shown in FIG. 26, in one or more embodiments, support device 204 may be designed to lay substantially horizontally or flat on the ground and comprise a hook or some another means (such as a rope, cable, or support strap, etc.) for operably connecting the containment testing device 100 to the support device 204.

FIG. 27 is a perspective view of one embodiment of containment testing device comprising two handles 113. FIG. 27 also shows first port 114 configured substantially in the center of base portion 102. Such configuration may aid a user using a camera system through first port 114 by providing substantially a 360-degree route to visualize conditions and/or leaks inside the targeted containment system. Although not shown, second port 116, third port 118 or some other port or means could be configured in substantially the center of base portion 102 instead of first port 114. Although not shown, the two handles 113 could assume various configurations.

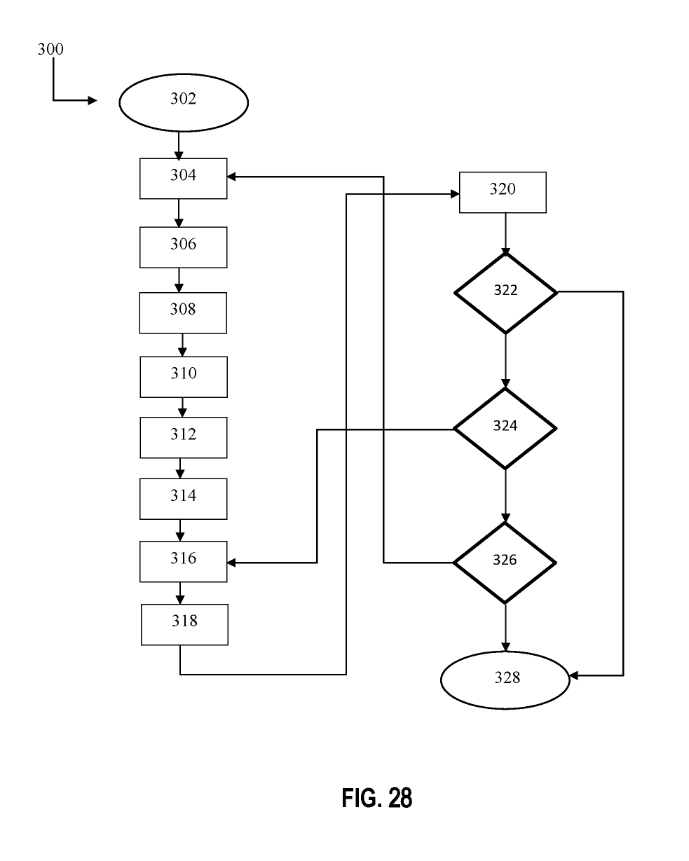

FIG. 28 is a flow diagram that depicts one embodiment of a method 300 for using containment testing device 100 in accordance with one embodiment. The method 300 for using containment testing device 100 as illustrated in flow diagram FIG. 28 may be customized, flexible and adapted to various circumstances and situations. Method 300 may be used to test the tightness of spill containment systems (such as spill containment system 30) and/or other containment systems.

At step 302, a user enters the process by removing a containment cover (such as spill containment cover 32) if it has not already been removed. At step 304, a user may remove any visible debris and/or perform a visual inspection of the containment system to determine its condition and/or if there are any obvious leaks in it. At step 306, a user may remove snap cap 40. At step 308, a user may remove fill adapter 42. At step 310, a user may remove a drop tube/overfill prevention device, if present, from fill pipe 38. At step 312, a user may isolate the containment system (such as spill containment system 30) from tank 20 and components of the containment system that may affect the test results. For example, in one or more embodiments, a user may install and actuate/inflate inflatable plug 146 below the drain's 49 opening in fill pipe 38 (such as illustrated and described in relation to FIG. 22) in order to isolate tank 20 from the targeted containment system and to ensure that the seal associated with drain 49 does not affect the test. A user may maintain the inflated state of inflatable plug 146 until the testing is completed. At step 314, a user may spray soap and water solution inside the targeted containment system (such as on its walls and bottom), as well as around the inflatable plug 146 to allow for visual evidence of its condition and/or the location of a leak in the event of a failed test.

At step 316, a user may install containment testing device 100 and inflate it (such as illustrated and described in relation to FIGS. 12, 13, 19, 20 and/or 21). The level of inflation pressure may depend on where containment testing device 100 is placed in the target containment system and/or how much surface area of the inflatable seal member 122 is in contact with the targeted containment system. For example, if containment testing device 100 is placed near the very top of spill containment ring 34 and/or spill bucket 36, less pressure may be required. A user may use discretion as to how much pressure is required to form a positive seal without damaging the containment testing device 100 and/or targeted containment system.

At step 318, a user may determine if a positive seal has been obtained between the containment testing device 100 and the targeted containment system. A user may make such determination by spraying soap and water solution where the containment testing device 100 and the targeted containment system interface. A user may apply positive pressure (such as via a compressor) within the containment system to test the tightness of the seal between the containment testing device and the targeted containment system. If no bubbles are observed where the containment testing device 100 and the targeted containment system interface (such as where said soap and water solution where/are sprayed), a positive seal has been achieved. If bubbles are observed, a positive seal has not been achieved, and containment testing device 100 may have to be resituated. In one or more embodiments, when applying positive pressure into the target containment system, a user may apply up to approximately 5 inches of water column through one of the ports (such as one that does not have the manometer 136 operably connected to it). Once a positive seal has been achieved between the containment testing device 100 and the target containment system, a user may proceed to determine if the targeted containment system is tight.

At step 320, a user may apply negative pressure (such as via a vacuum source) to target containment system. In one or more embodiments, such may be done through one of the ports (such as, for example, the same port positive pressure may be applied) to a pressure of about 30 inches of water column. In one or more embodiments, a user may apply about 30 inches of water column of negative pressure in the targeted containment system for about 1 minute.

At step 322, a user may monitor the level of pressure inside the containment system to determine if leaks exist. In one or more embodiments, a use may use manometer 136 (or some other pressure monitoring/measuring device) to monitor the level of pressure inside the isolated containment system. In one or more embodiments, a user may insert one end of hose 138 into manometer 136 and the other end into one of the ports on containment testing device 100 (such as, for example, first port 114, second port 116, and/or third port 118) to enable manometer 136 to monitor the pressure within the target containment system. In one or more embodiments, after the initial about 1 minute of negative pressure application, a user may close the valve on the negative pressure supply, record the time and level of pressure inside the containment system, and monitor the level of pressure within the containment system for approximately 1 minute. In one or more embodiment, a loss equal to or more than 4 inches of water column after 1-minute signals a failed test. Otherwise, the target containment system will have passed the test and is considered tight and a user can proceed to step 328.

In the event of a failed test at step 322, at step 324, a user may check the temporary seal between the containment testing device 100 and the targeted containment system for the presence of bubbles or other evidence of leaks. If bubbles are discovered on the seal or other evidence of leaks is discovered between containment testing device 100 and the targeted containment system (such as spill containment system 30), a user may need to resituate the containment testing device 100 and/or reestablish the temporary seal to remedy the leaks. Such may be accomplished by repeating any of the proper steps 316 through 318. Once a positive seal has been reestablished, a user may repeat steps 320 through 322 to test for leaks in the target containment system.

In the event of a failed test at step 322 and no leaks have been discovered at the temporary seal at step 324, at step 326, a user may check inside of the target containment system (such as, around fill pipe 38 and/or other places) for the presence of bubbles or other things which evidencing possible leaks in the target containment system. If the leak(s) can be remedied a user may repeat any of the applicable steps 304 through 326. If the leak(s) cannot be remedied or if it is determined that the target containment system is tight, a user proceeds to step 328.

At step 328, a user may de-pressurize the target containment system and inflatable seal member 122 and remove containment testing device 100 if such has not already done so. A user may document results at any time throughout the process.

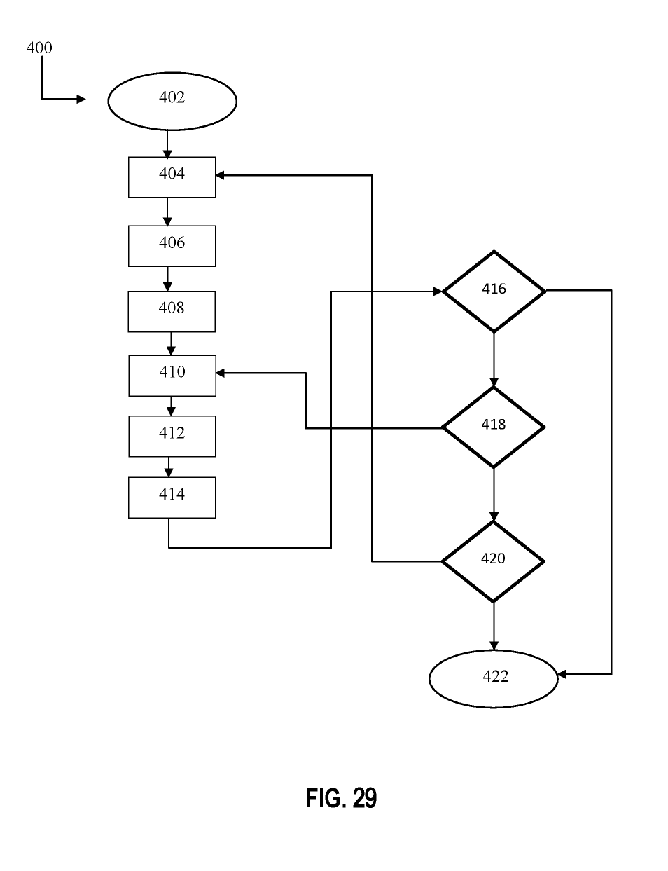

FIG. 29 is a flow diagram that depicts one embodiment of a method 400 for using containment testing device 100 in accordance with one embodiment. The method 400 for using containment testing device 100 as illustrated in flow diagram FIG. 29 may be customized, flexible and adapted to various circumstances and situations. Method 400 may be used to test the tightness of turbine sump systems (such as turbine sump system 60) and/or other containment systems.

At step 402, a user enters the process by removing a containment cover (such as turbine sump access cover 62 and turbine sump containment cover 65) if it has not already been removed. At step 404, a user may remove any visible debris and/or perform a visual inspection of the containment system to determine its condition and if there are any obvious leaks in it. At step 406, a user may isolate the containment system (such as turbine sump system 60) from tank 20 and components of the containment system that may affect the test results. At step 408, a user may spray soap and water solution inside the targeted containment system (such as on its walls and bottom) to allow for visual evidence of the location of a leak in the event of a failed test.

At step 410, a user may install containment testing device 100 and inflate it (such as illustrated and described in relation to FIGS. 24 and 26). The level of inflation pressure may depend on where containment testing device 100 is placed in the target containment system and/or how much surface area of the inflatable seal member 122 is in contact with the targeted containment system. For example, if containment testing device 100 is placed near the very top of turbine sump ring 64 and/or turbine sump containment 66, less pressure may be required. A user may use discretion as to how much pressure is required to form a positive seal without damaging the containment testing device 100 and/or targeted containment system.

At step 412, a user may determine if a positive seal has been obtained between the containment testing device 100 and the targeted containment system. A user may make such determination by spraying soap and water solution where the containment testing device 100 and the targeted containment system interface. A user may apply positive pressure (such as via a compressor) within the containment system to test the tightness of the seal between the containment testing device and the targeted containment system. If no bubbles are observed where the containment testing device 100 and the targeted containment system interface (such as where said soap and water solution where/are sprayed), a positive seal has been achieved. If bubbles are observed, a positive seal has not been achieved, and containment testing device 100 may have to be resituated. In one or more embodiments, when applying positive pressure into the target containment system, a user may apply up to approximately 5 inches of water column through one of the ports (such as one that does not have the manometer 136 operably connected to it). Once a positive seal has been achieved between the containment testing device 100 and the target containment system, a user may proceed to determine if the targeted containment system is tight.

At step 414, a user may apply negative pressure (such as via a vacuum source) to target containment system. In one or more embodiments, such may be done through one of the ports (such as, for example, the same port positive pressure may be applied) to a pressure of about 30 inches of water column. In one or more embodiments, a user may apply about 30 inches of water column of negative pressure in the targeted containment system for about 1 minute.

At step 416, a user may monitor the level of pressure inside the containment system to determine if leaks exist. In one or more embodiments, a use may use manometer 136 (or some other pressure monitoring/measuring device) to monitor the level of pressure inside the isolated containment system. In one or more embodiments, a user may insert one end of hose 138 into manometer 136 and the other end into one of the ports on containment testing device 100 (such as, for example, first port 114, second port 116, and/or third port 118) to enable manometer 136 to monitor the pressure within the target containment system. In one or more embodiments, after the initial about 1 minute of negative pressure application, a user may close the valve on the negative pressure supply, record the time and level of pressure inside the containment system, and monitor the level of pressure within the containment system for approximately 1 minute. In one or more embodiments, a loss equal to or more than 4 inches of water column after 1-minute signals a failed test. Otherwise, the target containment system will have passed the test and is considered tight and a user can proceed to step 422.

In the event of a failed test at step 416, at step 418, a user may check the temporary seal between the containment testing device 100 and the targeted containment system for the presence of bubbles or other evidence of leaks. If bubbles are discovered on the seal or other evidence of leaks is discovered between containment testing device 100 and the targeted containment system (such as turbine sump system 60), a user may need to resituate the containment testing device 100 and/or reestablish the temporary seal to remedy the leaks. Such may be accomplished by repeating any of the proper steps 410 through 412. Once a positive seal has been reestablished, a user may repeat steps 414 through 416 to test for leaks in the target containment system.

In the event of a failed test at step 416 and no leaks have been discovered at the temporary seal at step 418, at step 420, a user may check inside of the target containment system for the presence of bubbles or other things which evidencing possible leaks in the target containment system. If the leak(s) can be remedied a user may repeat any of the applicable steps 404 through 420. If the leak(s) cannot be remedied or if it is determined that the target containment system is determined to be tight, a user proceeds to step 422.

At step 422, a user may de-pressurize the target containment system and inflatable seal member 122 and remove containment testing device 100 if such has not already done so. A user may document results at any time throughout the process.

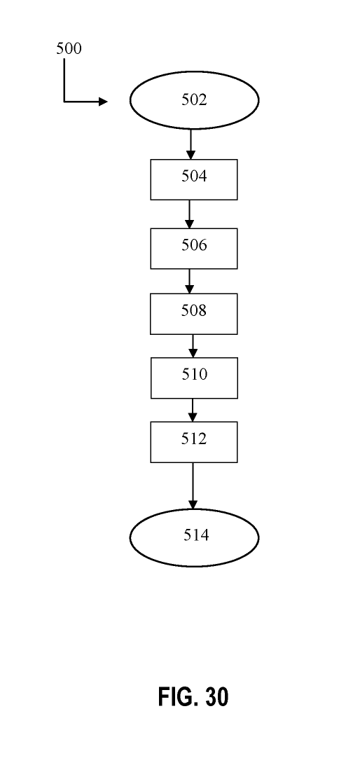

FIG. 30 is a flow diagram that depicts one embodiment of a method 500 for using containment testing device 100 in accordance with one embodiment. The method 500 for using containment testing device 100 as illustrated in flow diagram FIG. 30 may be customized, flexible and adapted to various circumstances and situations. Method 500 may be used to test the tightness of various containment systems (such as spill containment system 30 and/or turbine sump system 60).

At step 502, a user may remove at least one cover over the target containment system (such as spill containment system 30 and/or turbine sump system 60). At step 504, a user may install the containment testing device 100 at least partially inside the containment system and inflate the inflatable seal member to form a temporary seal between the containment testing device 100 and the containment system. At step 506, a user may apply positive pressure within the containment system to test the tightness of the seal between the containment testing device 100 and the containment system. At step 508, a user may monitor the level of pressure inside the containment system to determine whether a positive seal exists between the containment testing device 100 and the containment system. At step 510, a user may apply negative pressure within the containment system to test the tightness of the containment system. At step 512, a user may monitor the level of pressure inside the containment system to determine whether the containment system is tight. If the leak(s) cannot be remedied or if it is determined that the target containment system is tight, a user proceeds to step 514. At step 514, a user may de-pressurize the target containment system and inflatable seal member 122 and remove containment testing device 100 if such has not already done so. A user may document results at any time throughout the process. In one or more embodiments, any one or more steps and/or aspects of the steps of methods 300 and/or 400 may be combined with the steps of method 500.

Different embodiments of the disclosure may implement the above scenario(s) and/or variations of the above scenario(s). In one or more embodiment, any of the structures, functions, and/or features of any aspect of the disclosure described and/or illustrated herein may be combined with any of the structures, functions, and/or features of any other aspect of the disclosure described and/or illustrated herein. In one or more embodiments, each component of the disclosures may be provided in any color.

In one or more embodiments, other modifications may be made to the embodiments illustrated in the drawings and/or otherwise disclosed herein (including equivalents), which may include and/or have the capacity to utilize abilities, systems, devices, articles, means, functionality, features, methods and/or uses not expressly and/or impliedly described herein and/or illustrated in the drawings to this application but which may be obvious to one skilled in the art, whether developed later or known at the time of filing.

It should be understood that the present systems, devices, means, methods and structures are not intended to be limited to the particular forms disclosed; rather, they are to cover all combinations, modifications, equivalents and alternatives. A system, device, means, method or structure that is configured in a certain way may be configured in at least that way, but may also be configured in ways that are not described or illustrated herein. The disclosure may be configured to function with a variety of systems, devices, means, methods, and structures. Different materials may be used for individual components. Different materials may be combined in a single component.

The present disclosure may be embodied in other specific forms without departing from its spirit or essential characteristics. It is appreciated that various features of the above described examples and embodiments may be mixed and matched to form a variety of other combinations and alternatives. It is also appreciated that devices, methods and systems disclosed herein should not be limited simply to containment testing devices, methods and systems. The described embodiments are to be considered in all respects as illustrative and not restrictive. Other embodiments and/or implementations are within the scope of the following claims and at least all changes which come within the meaning and range of equivalency of the claims are to be embraced within their scope. The scope of the disclosure may be indicated by the appended claims rather than by any of the foregoing description.

The following claims may add additional clarity to this disclosure. Future applications claiming priority to and/or the benefit of this application may or may not include the following claims, and may or may not include claims broader, narrower, and/or entirely different from the following claims.

What is claimed is:

1. A containment testing device, comprising:
a base portion;
a wall portion comprising an exterior surface; and
an inflatable seal member situated on at least an aspect of the exterior surface, wherein the inflatable seal member, when inflated, provides a temporary seal between the containment testing device and a containment system.

2. The containment testing device of claim 1, further comprising: a first ledge portion and a second ledge portion, wherein the inflatable seal member is situated between the first ledge portion and the second ledge portion, wherein the first ledge portion and second ledge portion guide the direction the inflatable seal member expands and support it when the inflatable seal member is inflated.

3. The containment testing device of claim 1, further comprising a handle.

4. The containment testing device of claim 1, further comprising: a first port, a second port, a third port, and a fourth port.

5. The containment testing device of claim 4, further comprising: a first valve, a second valve, and a third valve.

6. The containment testing device of claim 5, wherein the inflatable seal member comprises a fill line for inflating the inflatable seal member.

7. The containment testing device of claim 6, wherein the fill line is disposed through the fourth port and is operably connected to the first valve, wherein the first valve is capable of controlling the flow of air going into and coming from the inflatable seal member and is capable of being operably connected to a compressor for inflating the inflatable seal member.

8. The containment testing device of claim 5, wherein the second valve is disposed through the second port and is capable of being operably connected to a manometer for monitoring the level of pressure in the containment system.

9. The containment testing device of claim 5, wherein the third valve is disposed through the third port and is capable of being operably connected to a compressor for providing positive and negative pressure to the containment system.

10. The containment testing device of claim 1, wherein the containment testing device is designed to test the tightness of a spill containment system.

11. The containment testing device of claim 1, wherein the containment testing device is designed to test the tightness of a turbine sump containment system.

12. The containment testing device of claim 1, wherein the containment testing device is configured to test the tightness of containment systems of various sizes.

13. The containment testing device of claim 1, wherein the containment testing device is configured to provide positive and negative pressure to the containment system.

14. The containment testing device of claim 1, wherein the containment testing device is configured with a means for measuring a change in pressure of at least 0.1 inches of water column in the containment system.

15. The containment testing device of claim 1, further comprising an inspection camera system for visualizing leaks in the containment system.

16. The containment testing device of claim 1, wherein at least an aspect of the base portion is configured from transparent material for visualizing leaks in the containment system.

17. The containment testing device of claim 3, wherein a support device operably connects to the containment testing device to provide stability and support to the containment testing device.

18. A containment testing device, comprising:
a base portion;
a wall portion comprising an exterior surface; and
a means for providing a temporary seal between the containment testing device and a containment system, wherein said means is inflatable.

19. A method of using a containment testing device to test the tightness of a containment system,
wherein the containment testing device comprising:
a base portion;
a wall portion comprising an exterior surface; and
an inflatable seal member situated on at least an aspect of the exterior surface,
wherein the inflatable seal member, when inflated, provides a temporary seal between the containment testing device and a containment system;
wherein the containment system comprising at least one cover;
wherein the method comprising:
removing the at least one cover from the containment system;
installing the containment testing device at least partially inside the containment system and inflating the inflatable seal member to form a temporary seal between the containment testing device and the containment system;
applying positive pressure within the containment system to test the tightness of the seal between the containment testing device and the containment system;
applying negative pressure within the containment system to test the tightness of the containment system; and
monitoring the level of pressure inside the containment system to determine whether the containment system is tight.

20. The method of claim 19,
wherein the containment system further comprising a fill pipe;
wherein the monitoring of the level of pressure inside the containment system is performed by use of a manometer;
wherein the method further comprising:
installing and inflating an inflatable plug in the fill pipe in order to isolate the containment system and control the tightness test of the containment system; and
maintaining the inflated state of the inflatable plug until testing is complete.
